(19) United States
(12) Patent Application Publication
(10) Pub. No.: US 2003/0081000 A1
(43) Pub. Date: May 1, 2003

(54) Method, program and computer system for sharing annotation information added to digital contents

(75) Inventors: Takeshi Watanabe, Yokohama-shi (JP); Yoichi Yoshida, Tokyo (JP); Eiichi Tazoe, Tokyo (JP)

Correspondence Address: A. Bruce Clay, IBM Corporation T81/503, PO Box 12195, Research Triangle Park, NC, 27709, US

(73) Assignee: International Business Machines Corporation, Armonk, NY

(21) Appl. No.: 10/282,964

(22) Filed: Oct. 29, 2002

(30) Foreign Application Priority Data
Nov. 1, 2001 (JP) 2001-335982

(51) Int. Cl. G09G 5/00

(52) U.S. Cl. 345/751; 345/753

(57) ABSTRACT

A mechanism for sharing information (annotation information) added to digital contents such as a Web page, by a plurality of users. An intermediate server is provided between a user's client terminal and a server managing digital contents. The user wishing to add annotation information to be shared, acquires the original digital contents via the intermediate server, not directly from the Web server. Then, the intermediate server caches the digital contents concerned and transmits them to the client terminal along with an annotation tool having a program for adding annotation information. Annotation information prepared by this annotation tool is stored in the intermediate server along with position information where it is displayed. For correlating the original digital contents and data about the annotation information with each other, a session key is produced as key information. The intermediate server produces address information (URL) for contents reproduction including data about the session key.

### DETAILED DESCRIPTION OF THE INVENTION

The present invention relates to a method of sharing information added to digital contents such as a Web page, and more specifically, relates to a method of sharing annotation information added to a desired position in such digital contents by a plurality of users.

### BACKGROUND OF THE INVENTION

Following the development of the Internet, many users can now share digital contents such as Web pages on the network. In general, when sharing information of a Web page on the Internet, a user as an information transmitter informs a URL (Uniform Resource Locator) being an address of the Web page to a third party user by means of an electronic mail or the like. The user having received such a URL being address information can display the content of the Web page on a Web browser by inputting that URL.

According to such a general method, it is relatively easy to share the content itself of the Web page by a plurality of users. However, it is inconvenient to inform a third party user about only a specific portion of the Web page or make a transmission by adding data. Specifically, in such an event, a user on the information transmitting side should transmit to a third party user an electronic mail or the like designating a specific portion along with a URL and describing a given comment (additional information), and the user on the receiving side should open a corresponding Web page based on such a URL, and retrieve and identify the designated portion by himself/herself.

For example, a user may find a term not clear in meaning while viewing a certain Web page, and think that he/she wishes to send a question about it to a creator (owner) of the Web page. In that event, it is necessary for the user to inform a URL of that Web page by means of an electronic mail or the like and identify an unclear portion, thereby to ask a question about it to the owner. The owner having received the question first inputs the URL to open the corresponding Web page, locates the associated portion in a document by himself/herself, and finally understands the content of the question. This, however, requires much time in handling and thus is not efficient. It is particularly inconvenient when the size of a composition in the Web page is large, the question extends over a plurality of portions, or a plurality of users share such additional information. Therefore, there is preferably a mechanism that can share not only the original Web page itself, but also additional information (annotation information) such as an annotation added by an individual user at a desired position in the Web page.

As an attempt to share the foregoing annotation information, an “Annotea” project of the W3C (World Wide Web Consortium) can be cited (http://w3.org/2001/Annotea). This is a project for extending a collaboration environment of the W3C by shared annotations and aiming to realize addition of an annotation without touching a document on the Web. Systematically, it is premised on introduction of a special editor and browser for editing and displaying an annotation on the side of a user (client). Annotation data is stored in an annotation server and, when a user views a document on the Web, an annotation is loaded from the annotation server, and the original document and the annotation are combined with each other on the client side.

However, the technique presented by the “Annotea” project is premised on the introduction of the special software on the client side, and thus has an aspect that is not entirely convenient for users. Further, a Web page subjected to addition of an annotation is acquired on the client side by referring to the original Web server upon every occasion of browsing the Web page, so that inconvenience is raised in such a dynamic Web page that is updated in content at predetermined time intervals. Specifically, because an existing Web page to be combined is not necessarily identical at a time point when an annotation is added thereto and at a time point when an annotation-added Web page is viewed, there is a chance of an occurrence of discrepancy in the displayed contents.

### Problems to be Solved by the Invention

It is an object of the present invention to solve the foregoing problems. Specifically, the object of the present invention is to provide a mechanism wherein a plurality of users can conveniently share not only digital contents such as a Web page referred to by the plurality of users, but also annotation information added thereto. In this case, it is desirable that there is no need to introduce a special system on the side of users.

Another object of the present invention is to provide a mechanism that can easily transmit a specific position within the foregoing digital contents to another user.

Still another object of the present invention is to provide an annotation information sharing mechanism applicable even to dynamic digital contents that are constantly changed.

### Means for Solving the Problems

For accomplishing the foregoing objects, in the present invention, an intermediate server is provided between a client terminal of a user and a server (Web server) managing digital contents. The user wishing to add annotation information to be shared acquires the original digital contents via the intermediate server, not directly from the Web server. In that event, the intermediate server caches the digital contents concerned and transmits them to the side of the client terminal along with an annotation tool being a program for adding annotation information. Annotation information prepared by this annotation tool is stored in the intermediate server along with position information where it is displayed. For correlating the original digital contents and annotation data being data for displaying the annotation information with each other, the intermediate server produces a session key as key information. The intermediate server produces address information (URL) for contents reproduction including data about the session key. By notifying this reproducing address information to other users, the user can share not only the original digital contents, but also the annotation information with the other users. To a user who accesses the intermediate server by inputting such reproducing address information, an annotation tool for preparing/displaying the annotation information is transmitted along with the contents embedded with the annotation information. A plurality of intermediate servers may be provided, each covering given unit for facilitating the management of handling data.

Specifically, the present invention is realized in a computer system (intermediate server) for sharing annotation information added to digital contents by a plurality of users, and, typically, comprises a first data base (contents data base) for storing the digital contents, a second data base (tool data base) for storing an annotation tool being a program for adding the annotation information to the digital contents, and a third data base (annotation data base) for storing the annotation information and position information for adding the annotation information at a proper position in the digital contents. Further, the computer system of the present invention comprises 1) means, responsive to receipt of a request from a user terminal for acquiring the digital contents, for acquiring the original digital contents from another computer system (Web server) holding the original digital contents, and storing them in the first data base in a manner correlated to univocally allocated key information, 2) means for acquiring the annotation tool from the second data base, and transmitting it to the user terminal along with the digital contents, 3) means for receiving the annotation information prepared using the annotation tool, along with the corresponding position information, and storing them in the third data base in a manner correlated to at least the key information, and 4) means for producing address information for displaying the digital contents embedded with the annotation information, such that the key information can be referred to.

The address information thus produced is notified to other users sharing the digital contents, by means of transmission to user terminals, or the like. The computer system of the present invention comprises means, responsive to receipt of such address information from the user terminal, for referring to the foregoing key information based on the address information to acquire the digital contents from the first data base and the annotation information and the position information from the third data base, and producing the digital contents embedded with the annotation information at a proper position, and further comprises means for transmitting an annotation tool having also a function of displaying the digital contents embedded with the annotation information, along with the digital contents concerned. This makes it possible to repeat production of additional annotation information even by other users, so that further sharing of the annotation information can be realized. It may also be configured that annotation information is embedded on the side of the user terminal, not on the side of the computer system. In this case, data and a program necessary for embedding the annotation information are transmitted to the side of the user terminal. Further, although the foregoing key information is allocated to single digital contents (e.g. one Web page) for convenience, it may be univocally allocated to a plurality of digital contents.

The present invention can also be realized as a method for sharing annotation information added to digital contents by a plurality of users, or as a program for causing a computer system to execute such a method.

### Preferred Embodiment of the Invention

Below, a preferred embodiment of the present invention will be described with reference to the drawings. Here, annotation information (annotation data) generically represents an annotation, a comment or other new information added to the original digital contents by a user. In this embodiment, a Web page is cited as a typical example of the digital contents to which annotation information is added. Accordingly, the annotation information may be text data, graphics data, animation data or sound data, or may have another data format as long as it can be handled on the Web.

### Outline of the Present Invention

FIG. 1 is a functional block diagram showing the overall structure of an information processing system including the present invention. The main processing of the present invention is executed in an intermediate server 10. The intermediate server 10 is connected to client terminals 30a and 30b and a Web server 40 via a network 20. The network 20 is typically the Internet, but may have a network structure other than that. A Web browser for referring to Web pages stored in the Web server 40 is loaded in each client terminal 30a, 30b. In general, a user starts up the Web browser and inputs a URL being address information, thereby to view a corresponding Web page stored in the Web server 40.

A user, who wishes to utilize an annotation information sharing mechanism of the present invention, first accesses the intermediate server 10. A Web page requested by the user is acquired from the Web server 40 via the intermediate server 10, and in that event, an annotation tool necessary for preparing/displaying annotation information is simultaneously downloaded. Thus, it is not necessary to introduce special programs in advance on the side of the client terminal 30a, 30b. Using this annotation tool, the user can add desired annotation information at a desired position on the Web page. The intermediate server 10 stores the annotation information input by the user, the position information in the Web page, and in addition, the acquired original Web page. This makes it possible to share annotation information even in case of a dynamic Web page that is frequently updated. The intermediate server 10 produces given address information (e.g. URL) based on those data, so that, by referring to such address information, other users sharing the annotation information can share the corresponding Web page with the annotation information. Hereinbelow, a structure of the intermediate server 10 will be described in detail.

### Structure of Intermediate Server

FIG. 2 is a functional block diagram showing the structure of the intermediate server 10. The intermediate server 10 comprises a processing section 12 and a data section 15 that have processing modules and data bases (DBs), respectively, necessary for realizing functions of the present invention.

A tool managing section 110 manages annotation tools for adding annotation information by users. Here, an annotation tool represents a program necessary for a user to add annotation information on a desired Web page, or to display annotation information added by another user. The annotation tools are stored in a tool DB 152. When a user accesses the intermediate server 10, the tool managing section 110 transmits a corresponding annotation tool along with an original Web page requested by the user, to the client terminal 30a, 30b.

The transmission of the annotation tool to the client terminal 30a, 30b can be performed in various ways. For example, when displaying an annotation tool in an original Web page, the following JavaScript(™) description is added into an HTML file of such a Web page.

<SCRIPT language=‘JavaScript’

src=‘http://[server]/Anno/annoadd.js’></SCRIPT>

Here, “JavaScript” is designated as a language to be used by <SCRIPT> tag, and “annoadd.js” stored in a directory called “Anno” of the same server is read out as an external file. In [server] portion, an address of the actual intermediate server 10 is described. “annoadd.js” is an external file including the annotation tool for adding annotation information, and is read out from the tool DB 152 and downloaded to the client terminal 30a, 30b along with the Web page. Rather than provided in the form of the external file as noted above, the annotation tool may, of course, be written directly into the HTML file of the contents.

On the other hand, when displaying an annotation tool in a window different from that of a Web page, the annotation tool is stored in the tool DB 152 as an HTML file separate from the Web page. FIG. 3 is a diagram showing an example of the tool DB 152 in that case. Here, annotation tools to be displayed are configured to have files of different contents depending on types of users accessing the intermediate server 10, for example, whether the user is a customer or a person in charge of making inquiries (agent).

A cache managing section 120 produces a session key in response to an input of address information (URL) of an original Web page requested by a user, stores the session key along with the original contents (Web page) in a manner correlated to the original contents, and transmits such contents along with a file (including an annotation tool) necessary for displaying a Web page for inputting annotation information, to the Web browser on the side of the client terminal 30a, 30b.

More specifically, an HTTP request processing section 122 first receives an HTTP request from the client terminal 30a, 30b. Because the HTTP (HyperText Transfer Protocol) itself is well known to a person skilled in the art, detailed explanation thereof is omitted herein. The HTTP request processing section 122 analyzes a header portion of the HTTP request from the client terminal 30a, 30b to identify a host name (address information) of the Web server 40 that actually acquires the contents.

Then, a cache contents managing section 124 transmits the HTTP request to the Web server 40 based on the identified address information to acquire original contents from the Web server 40 and stores them into a contents DB 154. In that event, path names of objects such as various files referred to by the contents are modified so as to be redirected by the intermediate server 10. FIG. 4 is a diagram illustrating data stored in the contents DB 154. All the files necessary for constructing the Web page at the time of the request by the user are stored in the contents DB 154.

A session key producing section 126 produces a session key and manages it in a manner correlated to the acquired contents. The session key is identification data univocally allocated when a user refers to certain desired contents (Web page). Preferably, for facilitating the management, a session key is allocated per Web page. On the other hand, if manageable, a session key may be allocated per unit of a plurality of Web pages (e.g. per unit of all the Web pages accessed by a user during one connection, or per unit of a plurality of Web pages located in the same directory). Further, it may also be arranged that a session key is produced upon every access request at a different time point or by a different user even in case of the same Web page. Data for such key information management is stored in a session DB 156.

FIG. 5 is a diagram illustrating data items for managing such key information. Here, it is configured that a table is provided per kind of data, and necessary data is identified by a pointer. Session data (a) manages the correspondence between session keys and contents cached in the intermediate server 10. Web data (b) holds data about Web pages acquired from the original Web server 40 and stored in the contents DB 154. Cookie data managed by individual data (c) is an optional item and, in this embodiment, it is configured that the cookie data is stored in the session DB 156 for enabling the authentication of users and the management of a transitional state between screen images in the Web browser of the client terminal 30a, 30b. By transmitting proper cookie data of a user to the Web server 40, the intermediate server 10 can receive digital contents that are the same as a Web page that is originally receivable by the Web browser.

Referring back to FIG. 2, an HTTP response producing section 128 produces an HTTP response based on the user requested contents redirected by the intermediate server 10 as described above, and transmits it to the client terminal 30a, 30b. In this event, an annotation tool is transmitted along with the contents.

An annotation managing section 130 manages data about annotation information added by a user using the annotation tool, and controls display (reproduction) of the Web page added with the annotation information.

More specifically, an annotation keeping section 132 receives the annotation information added by the user in the client terminal 30a, 30b along with information about a position, where the annotation information is added, in the Web page, and keeps them. There may be a plurality of annotation informations to be added. These annotation information and position information are stored in an annotation DB 158 in a manner correlated to data of the contents to which the annotation is added.

FIG. 6 is a diagram illustrating annotation data stored in the annotation DB 158. As shown in FIG. 6 at (a), data (annotation data) for properly displaying annotation information at given positions in corresponding Web pages are kept in a manner correlated to corresponding contents using session keys produced in the session key producing section 126. The session key is univocally assigned per given unit such as per Web page, and thus, only by identifying the session key, associated annotation data and contents can be both attained later. Details of the annotation data are managed in a separate table designated by a pointer in this embodiment.

FIG. 6 at (b) shows a more specified example of data about a position in a Web page to which annotation information is added. Here, a plurality of data entries are provided for one session key to enable addition of a plurality of annotation informations per session or page. Column of “location” stores information about given positions on a Web page to which annotation information is added. In this embodiment, the position information is described in a format of XPointer. XPointer is a standard format described subsequently to a URI (Uniform Resource Identifier) identifying a file, thereby to identify a given position in the file. For example, the position information of the first data item in FIG. 6 at (b) represents that annotation information is located at a position where “iSeries” of the first character string existing in H1 element of the third child element “child(3,H1)” of the head element “root( )” of a document is present. When a plurality of annotation informations are added, a plurality of such data are produced and managed similarly. Naturally, an annotation embedded in a different position has different data in column of “location”. Such position information is obtained through a given operation (e.g. operation of a right click of a mouse or range designation) by a user at a desired position on a displayed Web page. Further, in this embodiment, data about an author who prepared annotation information and the time thereof is added as additional information per annotation information. This makes it possible to recognize who prepared annotation information and when, even in case a plurality of users added the annotation information or one user added the annotation information plural times. In the structure of the present invention wherein a session key is allocated upon every request for access to a Web page, it is, of course, desirable to configure the data about the author and time as additional information of the session data shown in FIG. 6 at (a).

FIG. 6 at (c) shows a more specified example of the annotation data. The annotation data is managed per type depending on a characteristic of data. The “text” type represents a text (composition) that is actually described as an annotation, and the content of an actual comment is stored. The “GIF” type represents an image such as a photograph and is stored as an image file such as a GIF format. The “video” type represents animation data and is stored as an animation file such as an MPEG format. It is to be noted that, although not particularly illustrated herein, sound data or the like can also be similarly added as annotation information. In sum, as long as it is data that can be displayed as annotation information, it can be individually managed regardless of a file format.

It is also possible to keep the annotation data individually in a format of a JavaScript file (e.g. “12345.js”) having a session key as a part of its file name. This can realize a simple and convenient sharing method of annotation information using a session key as core.

Referring back to FIG. 2, after preparing and keeping the annotation data as described above, the annotation keeping section 132 produces a URL for reproducing (displaying) the Web page with the annotation. By inputting this reproducing URL using the general browser in the client terminal 30a, 30b, the Web page with the annotation can be displayed. This enables sharing of the annotation information by a plurality of users. As this reproducing URL, the following can be presented as an example.

http://[server]/ReplayURL?key=12345

wherein [server] is address information of the intermediate server 10. “/ReplayURL?key=12345” represents that, using a file or data having a value of “12345” as a key (session key) of a parameter in the same server, a program (ReplayURL) for reproducing a corresponding Web page is started up.

In response to an input of the foregoing reproducing URL, an annotation reproducing section 134 first acquires the session key. Then, referring to information of the session key, the annotation reproducing section 134 acquires corresponding annotation data and contents (Web page) from the annotation DB 158 and the contents DB 154, respectively. As described above, the annotation data holds the pointer information with respect to the cached original contents, and the annotation information and the position information thereof, in a manner correlated to the session keys. Thus, once the session key is given, the annotation reproducing section 134 can acquire data necessary for producing reproduction contents (contents for reproduction). Based on such data, the annotation reproducing section 134 produces the reproduction contents embedded with the annotation information at a proper position, and transmits them to the client terminal 30a, 30b along with an annotation tool for reproducing the contents.

For example, the annotation reproducing section 134 inserts the following tag into the reproduction contents.

<SCRIPT language=‘JavaScript’

src=‘http://[server]/Anno/data/12345.js’></SCRIPT>

<SCRIPT language=‘JavaScript’

src=‘http://[server]/Anno/annoplay.js’></SCRIPT>

wherein an address of the actual intermediate server 10 is described in [server] portion. “12345.js” represents an external file name describing annotation data corresponding to a session key of 12345 in JavaScript, and “annoplay.js” represents an external file name including a description of an annotation tool for reproducing annotation information. Both of them are read out from the annotation DB 158 and the tool DB 152, respectively, and downloaded to the side of the client terminal 30a, 30b along with the contents (Web page).

In the foregoing embodiment, the intermediate server 10 executes embedding of the annotation information into the contents. It is, however, possible to configure that it is executed on the side of the client terminal 30a, 30b. In this case, the execution on the side of the client terminal 30a, 30b is made possible by, for example, embedding a program described in JavaScript or the like for producing the reproduction contents into the contents (Web page) and transmitting them to the client terminal 30a, 30b.

### Processing Flow in Intermediate Server

Referring now to FIGS. 7 and 8, the processing flow among the intermediate server 10, the client terminal 30a, 30b and the Web server 40 will be described with the intermediate server 10 as core.

FIG. 7 is a diagram showing the processing flow in the intermediate server 10 when recording annotation information. A user wishing to share annotation information with other users first accesses the intermediate server 10, not the original Web server 40. The intermediate server 10 displays in the Web browser of the client terminal 30a, 30b an image requesting an input of address information (URL) of a Web page acquired by the user and, when the user inputs the address information, a HTTP request is transmitted to the intermediate server 10 (step S702). Specifically, the intermediate server 10 receives the address information (URL) of the Web page subjected to the annotation operation from the client terminal 30a, 30b in the form of the HTTP request. For requesting the contents (Web page) requested by the user, the HTTP request processing section 122 of the intermediate server 10 produces an HTTP request to the Web server 40 managing the Web page concerned based on the address information and transmits it to the Web server 40 (step S704). Then, the HTTP request processing section 122 awaits an HTTP response from the Web server 40 and acquires a file of the requested original contents (Web page) (step S706).

The cache contents managing section 124 of the intermediate server 10 correlates the original contents acquired from the Web server 40 with a session key being key information produced in the session key producing section 126, and stores them in a cache DB (contents DB 154) (step S710). Because the contents at the time of the user's request are once stored in the intermediate server 10 as noted above, even in case of the dynamic Web page whose contents are frequently updated, the user can share annotation information with other users by referring to the same Web page.

The HTTP response producing section 128 of the intermediate server 10 embeds an annotation tool acquired from the tool DB 152 managed by the tool managing section 110 into a file (HTML file) of the contents, and transmits it to the client terminal 30a, 30b as an HTTP response (step S712). Here, embedding the annotation tool includes, as described above, providing the annotation tool as an external file, or transmitting the annotation tool as an HTML file different from the contents. With this arrangement, the user can display an annotation tool along with a desired Web page on the Web browser of the client terminal 30a, 30b, and thus does not need to introduce a special tool beforehand. Specifically, the user can automatically obtain an annotation tool by accessing a desired Web page via the intermediate server 10.

FIG. 9 is a diagram showing an example of the annotation tool displayed in the client terminal 30a, 30b in that event. In the example of FIG. 9, a command box (a) for designating a command and an input box (b) for actually adding annotation information are displayed separately. In the initial stage, only the command box is displayed on a Web page or as a different window. A user first designates a position on the Web page where the user wishes to insert annotation information. This is implemented, for example, through an operation of range designation or an operation of a right click of a mouse performed in a normal screen operation. Alternatively, it may be arranged that annotation information is inserted at a position where a cursor is located at that time point. Subsequently, in the example of FIG. 9, the user selects (clicks) a “New” button in the command box. This causes the annotation information input box (b) to be displayed.

Here, explanation will be made of each button in the annotation tool. “New” in the command box is a button for newly preparing annotation information as noted above. For adding a plurality of annotation informations, this button is pushed upon every occasion of adding the annotation information. “Remove” is a button for deleting annotation information once input. “Show” and “Hide” are buttons for displaying and non-displaying annotation information displayed on a Web page at that time point, respectively. “OK” is a button for, upon completion of inputting prepared annotation information, temporarily holding the content of the annotation information on the side of the client terminal 30a, 30b. Specifically, in the stage where the “OK” button is pushed, the annotation data is not transmitted to the intermediate server 10. This enables processing to input a plurality of annotation informations at respective positions and then finally transmit them all together. “Apply” is a button for transmitting the input annotation information to the side of the intermediate server 10. “Close” is a button for closing the annotation tool itself, and “Help” is a button for displaying help information. The command box may, of course, have a simpler structure. For example, typically, the command box may be configured to have only a button for displaying the input box after the position designation by a user (corresponding to “New”), and a button for transmitting annotation data added with annotation information to the intermediate server 10 (corresponding to “Apply”).

The input box (b) is configured to enable a text, an image file, or an animation or other file to be input as annotation information. The content of the text is directly input into column of “Message”. With respect to the image or other file, by inputting location information (e.g. address information such as URL) thereof, it is referred to as annotation information. It is, of course, possible to configure input columns for those files as optional items. In this embodiment, it is configured that data about an input date and an author of annotation information can be added. However, it may be configured that these data are automatically prepared from information registered beforehand.

FIG. 10 is a diagram showing an example wherein the command box and the input box of FIG. 9 are displayed as one box. Because the function of each component of this box was already explained in association with FIG. 9, detailed explanation thereof is omitted herein.

Referring back again to FIG. 7, annotation information prepared by the user using the foregoing annotation tool is transmitted to the intermediate server 10 as an HTTP request. Specifically, by selection of the foregoing “Apply” button, the annotation information is transmitted along with position information representing a display position in the Web page concerned (step S714). The annotation keeping section 132 of the intermediate server 10 stores the received annotation data in the annotation DB 158 in a manner correlated to the session key being key information as described above (step S720). In this event, the information of the contents to be added with the annotation information is also stored in a manner correlated to the session key. Then, the annotation keeping section 132 produces the foregoing reproducing URL and transmits it to the client terminal 30a, 30b as an HTTP response (step S722). When the user transmits the reproducing URL to other users the user wishes to share the annotation information with, such other users can also access the annotation information. For example, the user of the client terminal 30a first adds annotation information to a desired Web page and then notifies a resultantly obtained reproducing URL to the user of the client terminal 30b by electronic mail or the like. By inputting this reproducing URL, the user of the client terminal 30b can automatically access the intermediate server 10 to refer to the annotation information added by the user of the client terminal 30a.

FIG. 8 is a diagram showing the processing flow in the intermediate server 10 when reproducing the Web page including the annotation information. The user first inputs the foregoing reproducing URL from the client terminal 30a, 30b to transmit an HTTP request to the intermediate server 10 (step S810). Based on the key information (information about the session key) included in the reproducing URL, the annotation reproducing section 134 of the intermediate server 10 acquires the annotation data and the contents stored beforehand in a manner correlated to the key information from the annotation DB 158 and the contents DB 154, respectively, and produces a file of the contents (Web page) embedded with the annotation information at a proper position (step S820). Specifically, as described above, because the annotation data includes information about a display position of each annotation information, such embedding of the annotation information at the proper position is made possible. On the other hand, this embedding operation is not necessarily required to be implemented on the side of the intermediate server 10, but may be implemented on the side of the client terminal 30a, 30b. In this case, a program for implementing the embedding operation is also transmitted to the side of the client terminal 30a, 30b along with the annotation information.

The annotation reproducing section 134 transmits not only a program for reproducing (displaying) annotation information, but also a program for editing (preparing) annotation information, as annotation tools along with the foregoing contents (step S830). This allows the user not only to browse the annotation information embedded by another user, but also to add an answer or supplementary comment thereto as annotation information. The processing flow of an annotation information registration in this event is as explained with reference to FIG. 7.

FIG. 11 is a diagram showing an example of a Web page actually incorporated with annotation information. In this figure, an annotation tool is displayed as a separate window, but may be displayed within the Web page as described above. By selecting (clicking or the like) a given symbol displayed in the Web page, annotation information already added is unfolded and displayed near the symbol. Preferably, this symbol of the annotation is highlighted by flashing or the like so as to be easily and explicitly recognized. On the other hand, the displayed annotation information can be set to a non-displaying state by selecting a “close” button. In this example, three annotation informations are embedded, each describing a preparation date, an author and the content of a message. A window of each annotation information is movable within the Web page after having been displayed, by operating a mouse or the like. Further, in this example, animation data is provided so as to be reproducible. By selecting a “Show Video” button, reproduction of embedded animation data is started. Although not particularly shown herein, it is also possible to embed sound data similarly. In this case, it is possible to configure that a guide composition is read out in a voice, or annotation information is read out in a voice.

In this embodiment, annotation items are individually displayed. On the other hand, it may be configured that items are first automatically displayed in a list such as an annotation list and, depending on a selection operation such as clicking by a user to select a desired annotation item, corresponding actual annotation information is displayed.

As described above, a user once notified of a reproducing URL can access a corresponding Web page to browse annotation information input by another user, and further prepare new annotation information by himself/herself and add it.

### Hardware Structure

FIG. 12 is a diagram exemplarily showing a hardware structure of a computer device such as a server or client terminal that is suitable for carrying out the present invention. The computer device shown in FIG. 12 comprises a CPU (Central Processing Unit) 102, a memory 104 such as a RAM connected to the CPU 102 via a bus 108, and a communication adapter 106 for connection to another computer device via the network. Further, the computer device can include a hard disk device 114, a flexible disk device 116 and a CD-ROM driving device 118 via an I/O adapter 110 such as an IDE controller or SCSI controller, and can further include user I/O devices such as a keyboard 120, a mouse 122 and a display unit 124 via a user interface adapter 112.

In the structure of the present invention, the respective functions of the processing section 12 of the intermediate server 10 are so-called virtual processing blocks that are realized by the CPU 102 controlled by a program loaded in the memory 104. In general, this program is stored in a recording medium such as a magnetic disk and supplied to the computer device via the FDD 116 or the CD-ROM 118, or is transmitted via the network and supplied to the computer device via the communication adapter 106. The program is generally stored in the hard disk device 114, loaded into the memory 104 upon execution thereof, and executed by the CPU 102. On the other hand, the data section 15 of the intermediate server 10 is realized by the hard disk device 114 and the memory 104, and supplies data to the processing section 12 upon request. It is to be noted that FIG. 12 only shows an example of the structure of the computer device that can realize this embodiment, and it is, of course, possible to adopt other system structures as long as this embodiment is applicable thereto.

### Advantages of the Invention

As described above, with the functions of the intermediate server of the present invention, the original digital contents (Web page or the like) and annotation information added thereto can be shared by a plurality of users without introducing special programs on the side of a client. Further, such annotation information is managed along with position information thereof, so that it can be definitely informed as to which portion of the original contents is to be watched. Moreover, after the original digital contents have once been stored in the intermediate server, necessary annotation information is added or displayed. Accordingly, sharing of the annotation information is made possible with respect to even such digital contents that are frequently updated.

### BRIEF DESCRIPTION OF THE DRAWINGS

FIG. 1 is a functional block diagram showing the overall structure of an information processing system including the present invention;

FIG. 2 is a functional block diagram showing a structure of an intermediate server 10;

FIG. 3 is a diagram showing an example of a tool DB 152;

FIG. 4 is a diagram illustrating data stored in a contents DB 154;

FIG. 5 is a diagram illustrating data items for managing key information;

FIG. 6 is a diagram illustrating annotation data stored in an annotation DB 158;

FIG. 7 is a diagram showing the processing flow in the intermediate server 10 when recording annotation information;

FIG. 8 is a diagram showing the processing flow in the intermediate server 10 when reproducing a Web page including annotation information;

FIG. 9 is a diagram showing an example of an annotation tool displayed in a client terminal 30a, 30b;

FIG. 10 is a diagram showing an example wherein a command box and an input box of FIG. 9 are displayed as one box;

FIG. 11 is a diagram showing an example of a Web page actually incorporated with annotation information; and

FIG. 12 is a diagram exemplarily showing a hardware structure of a computer device such as a server or client terminal that is suitable for carrying out the present invention.

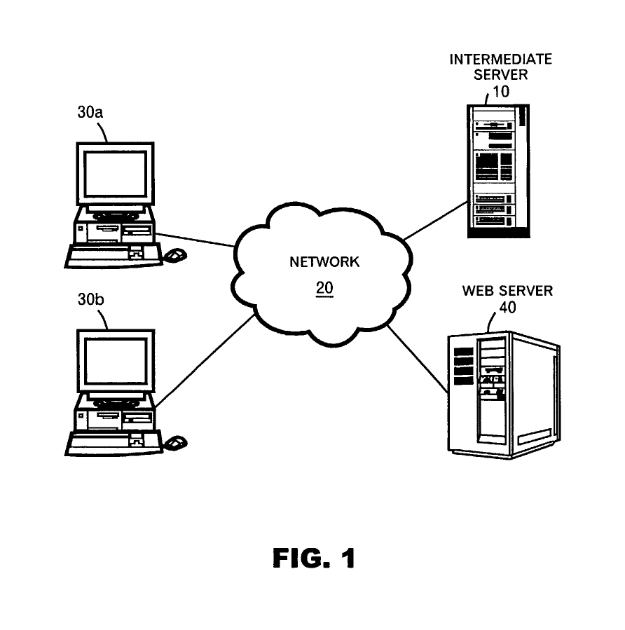

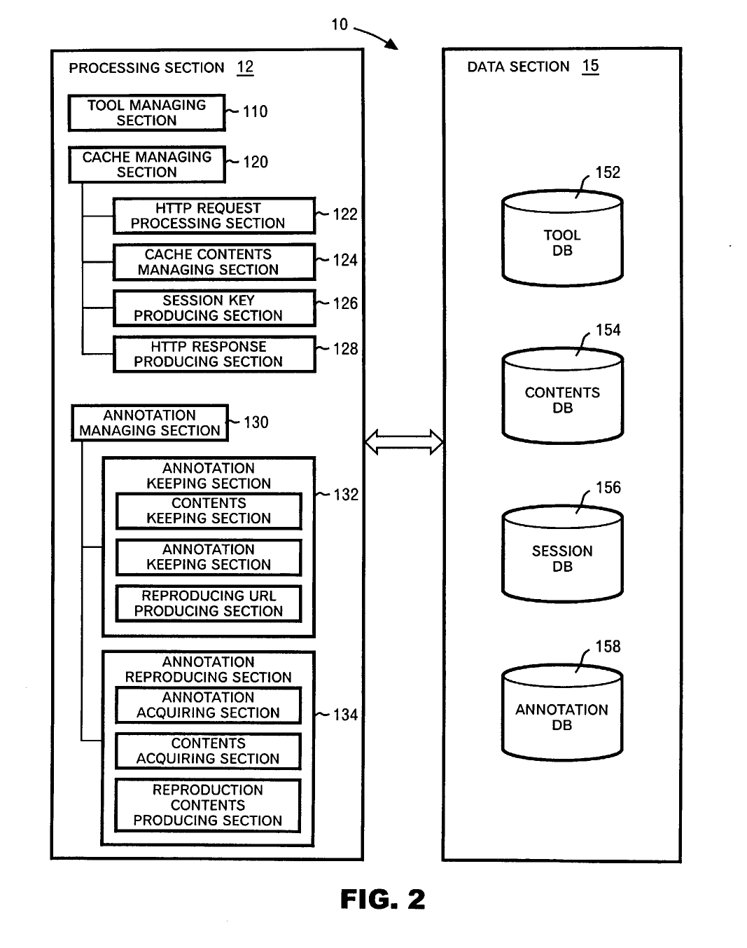

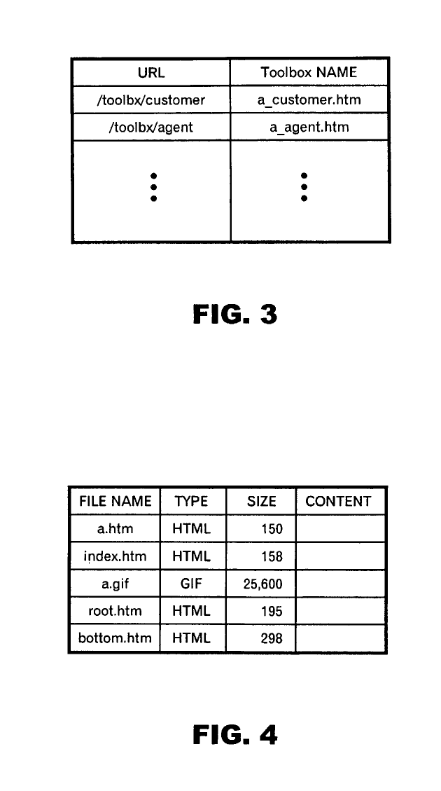

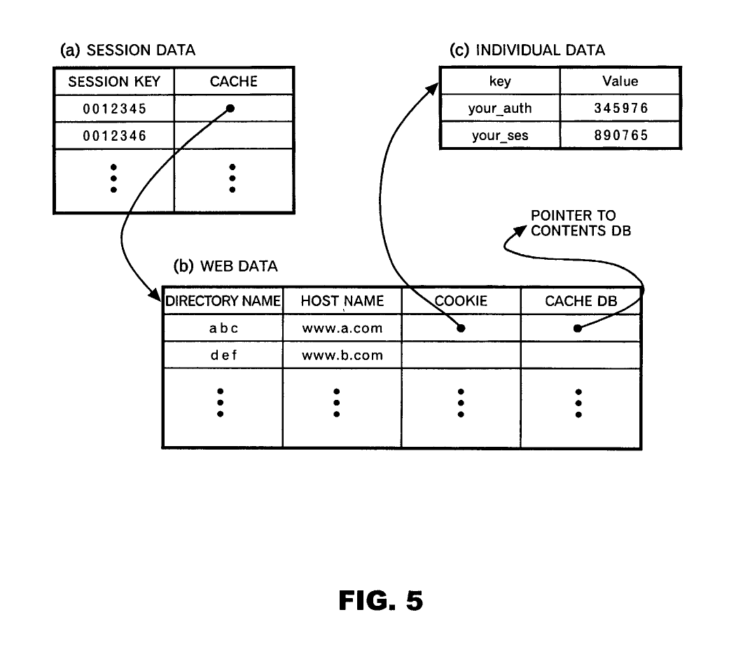

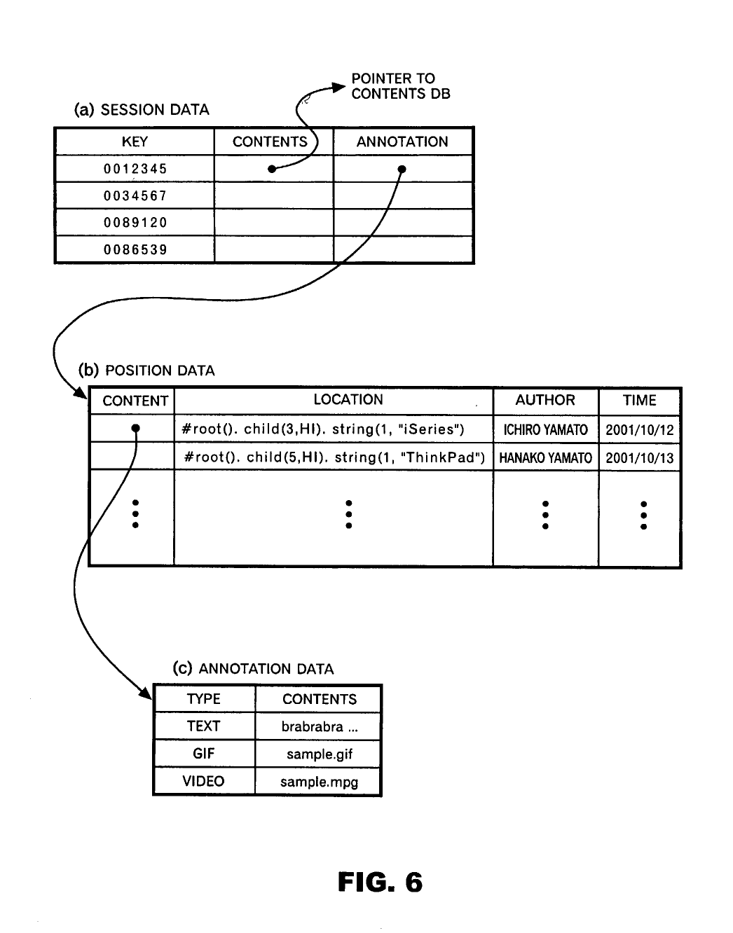

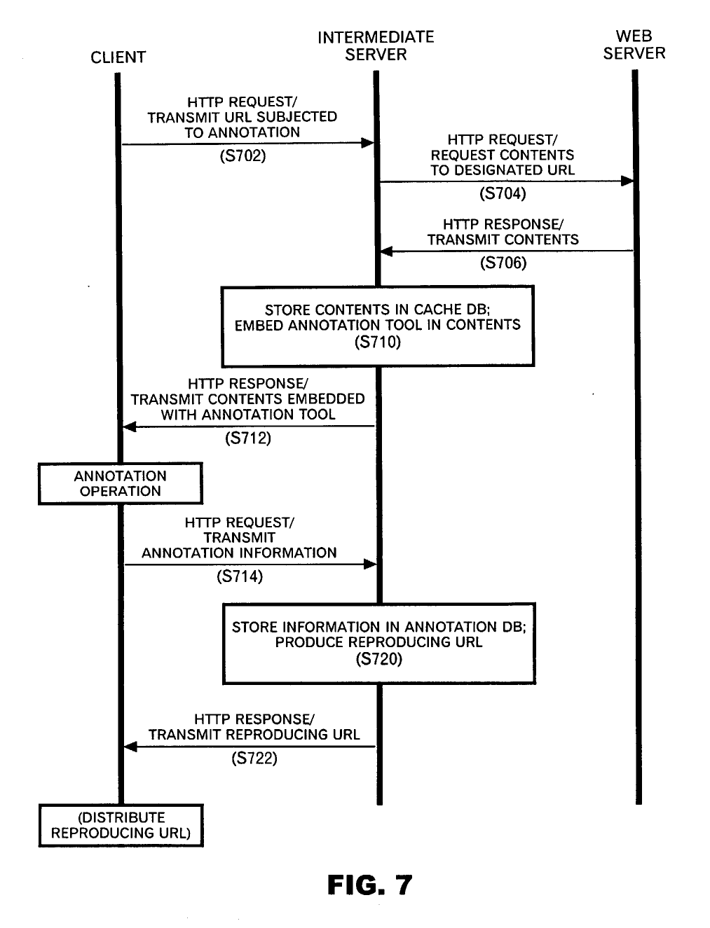

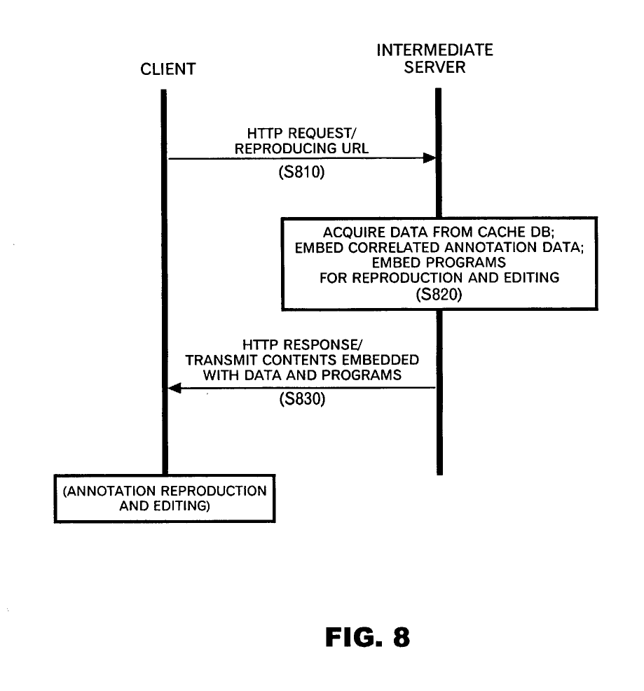

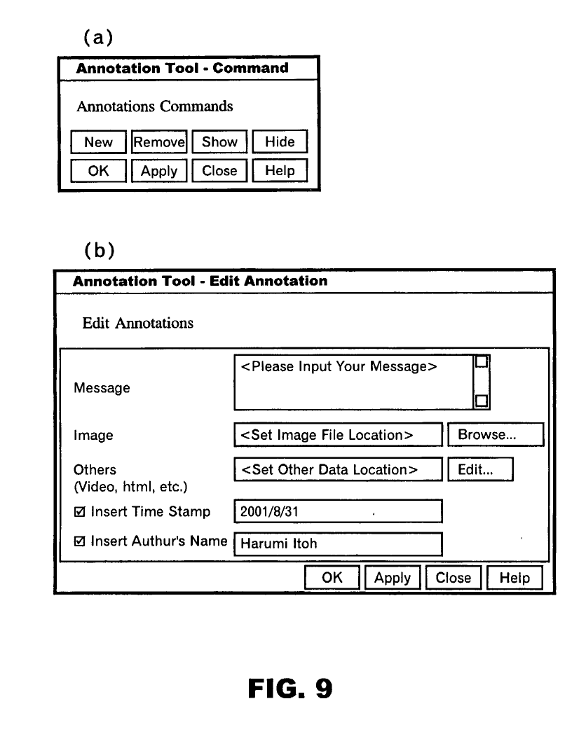

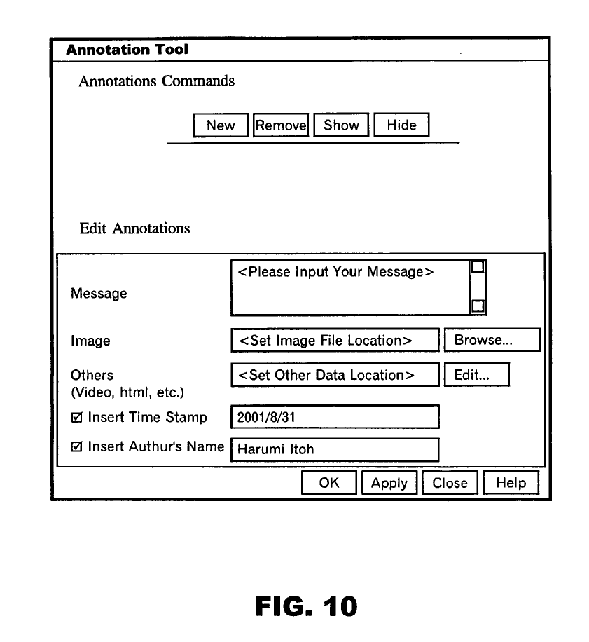

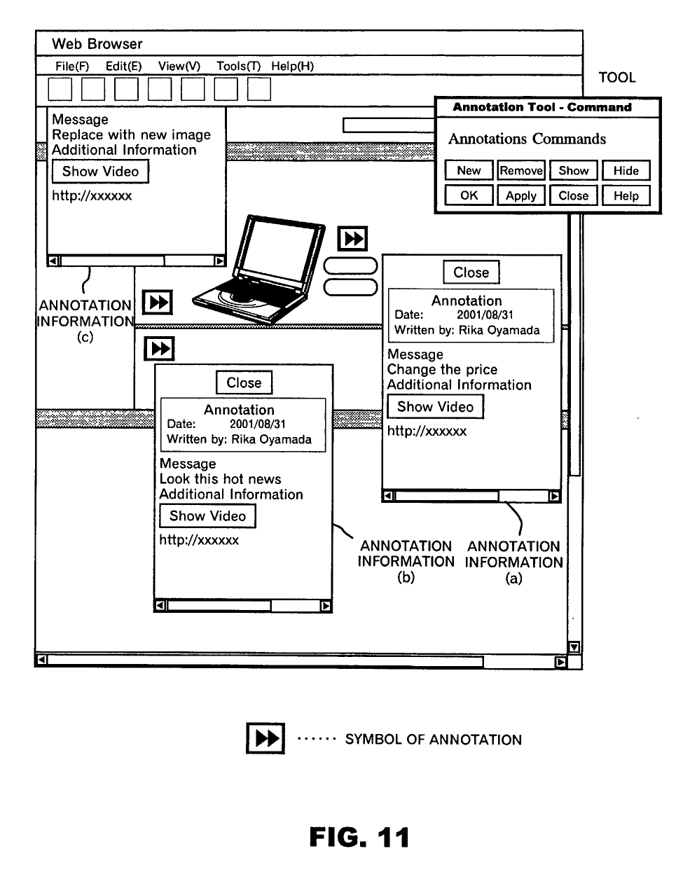

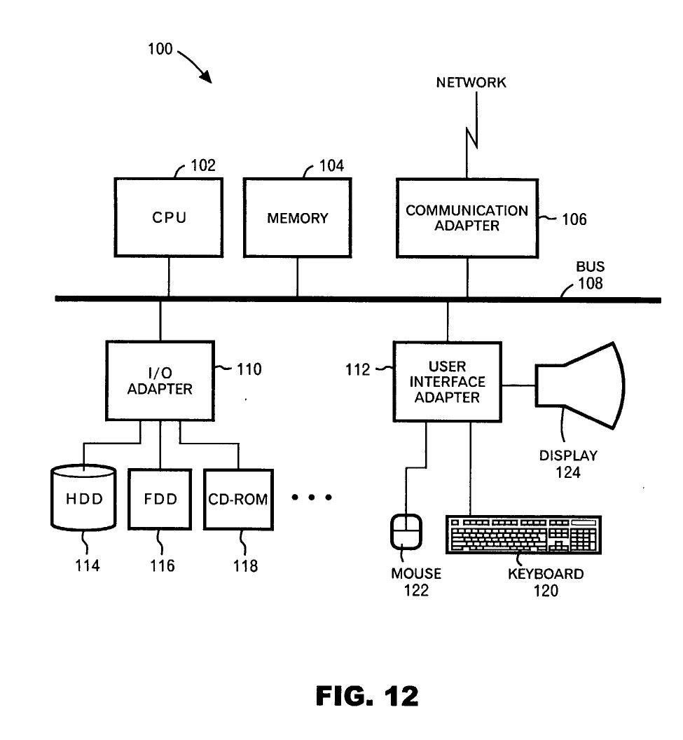

What is claimed:

1. An annotation information sharing method for sharing annotation information added to digital contents by a plurality of users, said method comprising the steps of:
receiving a request from a user terminal for acquiring the digital contents;
acquiring the digital contents from a computer system holding said digital contents, and storing them in a first data base in a manner correlated to univocally allocated key information;
transmitting said digital contents and a first tool being a program for adding the annotation information, to said user terminal;
receiving the annotation information prepared using said first tool, along with position information for displaying said annotation information at a given position in said digital contents, and storing them in a second data base in a manner correlated to at least said key information; and
producing address information for displaying the digital contents embedded with said annotation information, such that said key information can be referred to.

2. An annotation information sharing method according to claim 1, further comprising the step of transmitting said address information to one or a plurality of user terminals.

3. An annotation information sharing method according to claim 1, further comprising the steps of:
receiving said address information from an arbitrary user terminal; and
referring to said key information based on said received address information to acquire said digital contents from said first data base and said annotation information and said position information from said second data base, and producing the digital contents embedded with said annotation information at a proper position.

4. An annotation information sharing method according to claim 3, further comprising the step of transmitting a second tool for displaying said produced digital contents and adding other annotation information, to said arbitrary user terminal along with said digital contents.

5. An annotation information sharing method according to claim 1, further comprising the steps of:
receiving said address information from an arbitrary user terminal;
referring to said key information based on said received address information to acquire said digital contents from said first data base and said annotation information and said position information from said second data base; and
transmitting, along with said acquired digital contents, annotation information and position information, a program for embedding said annotation information at a proper position in said digital contents to said arbitrary user terminal.

6. An annotation information sharing method according to claim 1, wherein said key information is univocally allocated to a plurality of digital contents, in the step of storing into said first data base.

7. A computer system for sharing annotation information added to digital contents by a plurality of users, said computer system comprising:
a first data base for storing the digital contents;
a second data base for storing a first tool being a program for adding the annotation information to the digital contents;
a third data base for storing the annotation information and position information for adding the annotation information at a proper position in the digital contents;
means for receiving a request from a user terminal for acquiring the digital contents, acquiring the digital contents from another computer system holding said digital contents, and storing them in said first data base in a manner correlated to univocally allocated key information;
means for acquiring said first tool from said second data base, and transmitting it to said user terminal along with said digital contents;
means for receiving the annotation information prepared using said first tool, along with said corresponding position information, and storing them in said third data base in a manner correlated to at least said key information; and
means for producing address information for displaying the digital contents embedded with said annotation information, such that said key information can be referred to.

8. A computer system according to claim 7, further comprising means for transmitting said address information to one or a plurality of user terminals.

9. A computer system according to claim 7, further comprising means for receiving said address information from an arbitrary user terminal, referring to said key information based on said received address information to acquire said digital contents from said first data base and said annotation information and said position information from said third data base, and producing the digital contents embedded with said annotation information at a proper position.

10. A computer system according to claim 9, wherein a second tool being a program for displaying the digital contents embedded with said annotation information and adding other annotation information is stored in said second data base, further comprising means for transmitting said second tool to said arbitrary user terminal.

11. A computer system according to claim 7, further comprising:
means for receiving said address information from an arbitrary user terminal, and referring to said key information based on said address information to acquire said digital contents from said first data base and said annotation information and said position information from said third data base; and
means for transmitting, along with said acquired digital contents, annotation information and position information, a program for embedding said annotation information at a proper position in said digital contents to said arbitrary user terminal.

12. A computer system according to claim 7, wherein said key information is univocally allocated to a plurality of digital contents in said first data base.

13. A data processing system comprising said computer system according to any one of claims 7 to 12, and a server system storing the original of said digital contents.
